(19) United States
(12) Patent Application Publication
(10) Pub. No.: US 2008/0195648 A1
(43) Pub. Date: Aug. 14, 2008

(54) METHOD, SYSTEM AND PROGRAM FOR PROVIDING PRINTED MATTER

(75) Inventor: Keizaburo Matsumoto, Kitakyushu-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MATSUMOTO INC., Kitakyushu-shi (JP)

(21) Appl. No.: 11/746,858

(22) Filed: May 10, 2007

(30) Foreign Application Priority Data
Feb. 8, 2007 (JP) 2007-29476

(51) Int. Cl. G06F 7/00

(52) U.S. Cl. 707/102; 707/E17.044

(57) ABSTRACT

Content classifying means 24 for storing content data, identification information of the content data, and content provider information received from a terminal device 12 of a content provider, and creating a content table 25; searching means 27 for searching the content table 25 using a keyword and a search formula obtained from a terminal device 13 of a recipient of printed matter, and identifying content that matches a search criteria; composition data generating means 29 for generating composition data from the content data of the specified content; sending means 30 for sending the composition data and delivery address information to a printing device 14; and billing means 31 for generating billing data for the content provider according to output quantity of the content from the sending means 30, thereby providing printed matter containing the selected content.

### BACKGROUND OF THE INVENTION

The present invention relates to a method, system and program for providing printed matter. More particularly, the present invention relates to the method and system for providing printed matter capable of delivering printed matter having content selected by a recipient of printed matter via a screen displayed on a terminal device connected to a computer network to a delivery address designated by the recipient, and the program for executing the method and system.

Information on commercial products and services are obtained, e.g., through informational magazines. In recent years, various informational magazines have been published, reflecting diversity in preference of recipients of printed matter. In addition to various pay magazines sold at low prices at bookstores, station kiosks, convenience stores, etc., free magazines distributed at stands installed, e.g., at stations have been increasingly published.

Although expense paid by a magazine reader is small, in many cases, information necessary for the reader is contained in only part of the articles and advertisements in the magazine. Thus, obtaining information through magazines is not efficient, and it may cause waste of resources.

Meanwhile, web search using a personal computer or a PDA (personal digital assistant) is becoming an effective way for collecting information as the Internet develops. The web search is advantageous in that the search can be carried out at home at any time. With the popularization of the PDA, it has become possible to carry out the web search outdoors or at travel destinations, which is another advantage of the web search.

However, to accurately find desired information from the flood of information on the Internet, a certain degree of skill and knowledge is required. Additionally, steps of selecting necessary information from unorganized information and printing it using a printer cause a great waste of time. Also, operation of the information equipment may be difficult especially for the elderly.

Since information printed on paper is more convenient than that displayed on a screen, information on a website found through a search is often printed out with a printer. Information printed on paper is portable and thus the obtained information can be used anywhere. However, printing with a printer is more costly than printing of printed matter such as books. Moreover, when the information is in a large amount, the printed paper becomes disadvantageously bulky. Moreover, printing information is difficult when the user is outdoors or uses the PDA.

From the standpoint of information providers, on the other hand, the cost of placing advertisements in the informational magazines is currently very high. Providing information through the Internet requires skill to establish infrastructure, prepare content, etc., and also, troubles and costs arising from maintaining the website and obtaining a certain number of page views are not negligible. Moreover, information providers must bear high costs before knowing whether the information will be actually used or not.

In recent years, with the development of an on-demand printing system, a system has been proposed in, e.g., Japanese Patent Application Publication No. 2003-242388 capable of quickly printing out content desired by a customer on a paper medium on the spot in the form of printed matter and selling the printed matter.

Furthermore, e.g., Japanese Patent Application Publication No. 2002-82931 proposes an on-demand document preparation system capable of preparing and providing documents having different content for different customers.

### SUMMARY OF THE INVENTION

However, a system for providing information has yet to be developed, which is capable of solving the problems of the informational magazines and Internet search found by the information senders and recipients.

In view of the above, an object of the present invention is to provide a method, system and program for providing printed matter, capable of reducing costs, and saving time and troubles for both the information providers and information recipients.

A first aspect of the present invention provides a method for providing printed matter using a computer connected to a computer network, the printed matter having content selected by a recipient of the printed matter via a screen displayed on a terminal device connected to the computer network, the method comprising the steps of:

(A) receiving content data, identification information of the content data, and content provider information from a terminal device of a content provider via the computer network by data input/output means of the computer, and storing the content data, the identification information, and the content provider information in storage means of the computer;

(B) creating a content table in which the content provider information and the identification information are stored for each of the content data stored in the storage means by content classifying means of the computer;

(C) acquiring a keyword and a search formula necessary to identify content desired by the recipient from the terminal device of the recipient, and storing the keyword and search formula in the storage means by keyword acquisition means of the computer via the computer network;

(D) searching the content table by searching means of the computer using the acquired keyword and the search formula to identify content that matches a search criterion;

(E) reading content data of the identified content from the storage means by composition data generating means of the computer, and generating composition data using the content data;

(F) acquiring delivery address information of the printed matter from the terminal device of the recipient by the data input/output means, and storing the delivery address information in the storage means;

(G) sending the composition data and the delivery address information to a printing device connected to the computer by sending means of the computer; and

(H) generating billing data for the content provider according to output quantity of the content by billing means of the computer.

According to the method of the present invention, the printed matter having content selected by the recipient is prepared in response to a request of the recipient. Therefore, the content provider can provide the recipient with only information required by the recipient as printed matter while eliminating the waste of resources accompanied by preparation and delivery of unnecessary printed matter. Meanwhile, the recipient can quickly obtain the printed matter containing desired content only. The printed mater is sent to a delivery address designated by the recipient. Accordingly, the recipient of the printed mater can obtain the printed matter containing only necessary information even at his/her travel destination. The fee is charged to the content provider according to the output quantity of the printed matter. Thus, the recipient can obtain the printed matter containing necessary content with little trouble and expense. Furthermore, the content provider can provide content without paying a large cost in advance, and also easily evaluate cost-effectiveness of advertisements based on the billing data which is proportional to the output quantity.

It is preferable that the method further comprises, prior to the step (A), the step of: (I) providing the terminal device of the content provider with a function to edit image and text data on a screen of the terminal device of the content provider and generate the content data by editing means of the computer via the data input/output means.

Since the content data can be generated by editing the image and text data on the screen displayed on the terminal device of the content provider, the content data can be easily generated without knowledge or experience in the preparation of manuscripts for printing.

The method may further comprise, between the steps (D) and (E), the step of:

(J) displaying a list of the content that matches the search criterion on the screen of the terminal device of the recipient by content selecting means of the computer to allow the recipient to select desired content, acquiring information on the selected content from the terminal device of the recipient via the data input/output means, and storing the information in the storage means,

wherein the step (E) includes generating the composition data by the composition data generating means using content data of the selected content.

The method permits the recipient to select desired content from the list of the content that matches the search criterion, thereby generating the composition data from the selection result obtained from the terminal device of the recipient. As a result, the printed mater in which only the content desired by the recipient is printed can be provided.

The second aspect of the present invention provides a system for providing printed matter, comprising:

data input/output means for sending and receiving data to and from terminal devices of a content provider and a recipient of printed matter via a computer network, the terminal devices being connected to the computer network;

storage means for storing content data received from the terminal device of the content provider via the data input/output means, identification information of the content data, content provider information, a keyword and a search formula for identifying content desired by the recipient received from the terminal device of the recipient via the data input/output means, information on content selected by the recipient, and delivery address information of printed matter in which the selected content is printed;

content classifying means for creating a content table in which the content provider information and the identification information are stored for each of the content data stored in the storage means;

keyword acquisition means for acquiring the keyword and the search formula for identifying the content desired by the recipient from the terminal device of the recipient via the computer network;

searching means for searching the content table using the keyword and the search formula to identify content that matches a search criterion;

composition data generating means for generating composition data from content data of the identified content;

sending means for sending the composition data and the delivery address information to a printing device via the computer network; and

billing means for calculating output quantity for each of the content data sent from the sending means and generating billing data for the content provider according to the output quantity.

Here, the term “terminal device of the recipient of the printed matter” includes a personal computer and a PDA such as a mobile phone (the same hereinafter).

According to the system of the present invention, the printed matter having content selected by the recipient is prepared in response to a request of the recipient. Therefore, the content provider can provide the recipient with only information required by the recipient as printed matter while eliminating the waste of resources accompanied by preparation and delivery of unnecessary printed matter. Meanwhile, the recipient can quickly obtain the printed matter containing desired content only. The printed mater is sent to a delivery address designated by the recipient. Accordingly, the recipient of the printed mater can obtain the printed matter containing only necessary information even at his/her travel destination. The fee is charged to the content provider according to the output quantity of the printed matter. Thus, the recipient can obtain the printed matter containing necessary content with little trouble and expense. Furthermore, the content provider can provide content without paying a large cost in advance, and also easily evaluate cost-effectiveness of advertisements based on the billing data which is proportional to the output quantity.

It is preferable that the system further comprises editing means for providing the terminal device of the content provider with a function to edit image and text data on a screen of the terminal device of the content provider to generate the content data.

Since the content data can be generated by editing the image and text data on the screen displayed on the terminal device of the content provider, the content data can be easily generated without knowledge or experience in the preparation of manuscripts for printing.

The system may further comprise content selecting means for creating a list of candidates of the content identified by the searching means, sending the list to the terminal device of the recipient via the data input/output means to allow the recipient to select content to be printed, and receiving information on the selected content via the data input/output means,

wherein the composition data generating means generates the composition data from content data of the selected content.

The system permits the recipient to select desired content from the list of the content that matches the search criterion, thereby generating the composition data from the selection result obtained from the terminal device of the recipient. As a result, the printed mater in which only the content desired by the recipient is printed can be provided.

A third aspect of the present invention provides a program for providing printed matter, causing a computer connected to a computer network to function as:

(A) means for receiving content data, identification information of the content data, and content provider information from a terminal device of a content provider via the computer network, and storing the content data, the identification information, and the content provider information in storage means of the computer;

(B) means for creating a content table in which the content provider information and the identification information are stored for each of the content data stored in the storage means;

(C) means for acquiring a keyword and a search formula for identifying content desired by a recipient of printed matter from a terminal device of the recipient via the computer network, and storing the keyword and the search formula in the storage means;

(D) means for searching the content table using the acquired keyword and search formula to identify content that matches a search criterion;

(E) means for combining content data of the identified content to generate composition data;

(F) means for acquiring delivery address information of printed matter from the terminal device of the recipient after the generation of the composition data;

(G) means for sending the composition data and the delivery address information to a printing device; and

(H) means for generating billing data for the content provider according to output quantity of the content.

According to the program of the present invention, the system for providing printed matter for achieving the above effects is constructed in the computer connected to the computer network, thereby enabling execution of the method for providing printed matter.

It is preferable that the program further causes a computer to function as: (I) means for providing the terminal device of the content provider with a function to edit image and text data on a screen of the terminal device of the content provider and generate the content data

The program may further cause a computer to function as:

(J) means for displaying a list of the content that matches the search criterion on a screen of the terminal device of the recipient to allow the recipient to select desired content and acquiring information on the selected content from the terminal device of the recipient,

wherein the means (E) further includes generating the composition data based on content data of the selected content

### BRIEF DESCRIPTION OF THE DRAWINGS

FIG. 1 is a descriptive illustration showing a system for providing printed matter according to one embodiment of the present invention connected to a terminal device via a computer network.

FIG. 2 is a block diagram showing a configuration of the system.

FIG. 3 is a sequence chart showing operation of the system.

### DESCRIPTION OF THE PREFERRED EMBODIMENT

For a more complete understanding of the present invention, one embodiment of the present invention is now described with reference to the accompanying drawings.

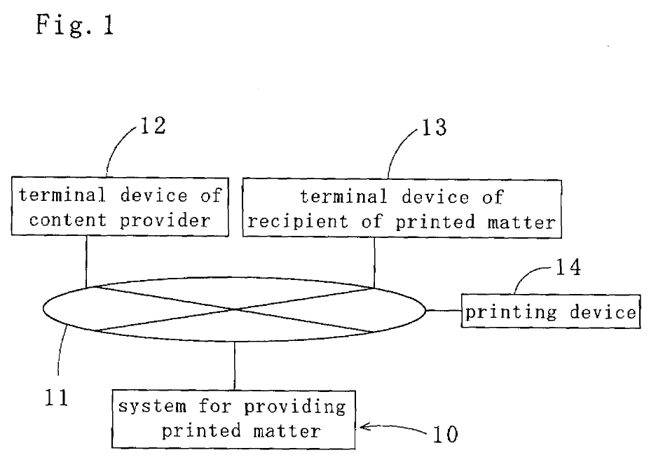

Referring to FIGS. 1 to 3, a system 10 for providing printed matter according to one embodiment of the present invention is described.

As shown in FIG. 1, the system 10 for providing printed matter is connected to a computer network 11. A terminal device 12 of a content provider, a terminal device 13 of a recipient of printed matter, and a printing device 14 are connected to the computer network 11.

The computer network 11 may be wired or wireless, and may be connected to the Internet.

The terminal device 12 of the content provider is connected to the system 10 for providing printed matter (hereinafter also simply referred to as “system”) via the computer network 11. Since content data is edited on a screen, the terminal device 12 is preferably a personal computer, a workstation, etc. having CPU, RAM, ROM and I/O therein.

The terminal device 13 of the receiver of printed matter is connected to the system 10 via the computer network 11. The terminal device 13 may be a handheld terminal such as a mobile phone as well as a personal computer and a workstation, as long as it is connectable to the computer network 11 and capable of receiving and sending data from and to the system 10.

The printing device 14 is connected to the system 10. The printing device 14 receives composition data generated by the system 10, and produces printed matter. The printing device 14 may be connected to the system 10 either directly or via the computer network 11 as in the present embodiment.

The printing device 14 may be either a page printer having only print functions or an information terminal having print functions installed, e.g., in a storefront of a convenience store. However, the printing device 14 is preferably an on-demand printer having booklet-binding functions such as saddle-stitching, folding, and edge-trimming functions.

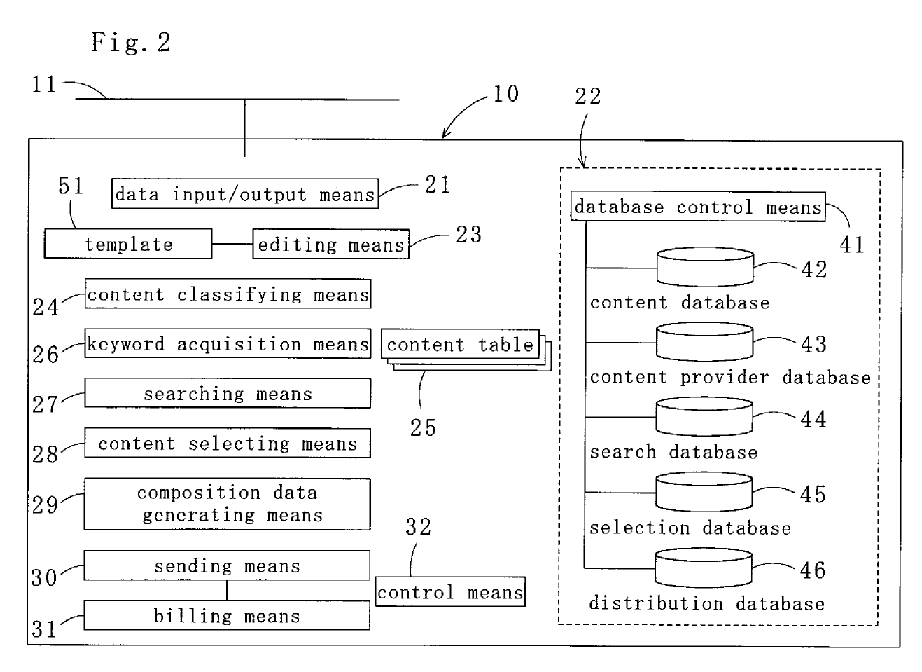

FIG. 2 shows a configuration of the system 10 for providing printed matter. The system 10 includes data input/output means 21, storage means 22, editing means 23, content classifying means 24, a content table 25, keyword acquisition means 26, searching means 27, content selecting means 28, composition data generating means 29, sending means 30, billing means 31, and control means 32 for controlling the entire system.

A program for providing printed matter loaded into a computer connected to the computer network 11 is executed by CPU. Accordingly, the computer functions as the data input/output means 21, the storage means 22, the editing means 23, the content classifying means 24, the content table 25, the keyword acquisition means 26, the searching means 27, the content selecting means 28, the composition data generating means 29, the sending means 30, the billing means 31, and the control means 32 for controlling the entire system.

The data input/output means 21 exchanges data required for production of printed matter with the terminal device 12 of the content provider and the terminal device 13 of the recipient through the computer network 11. A protocol (communication procedure) used for the data transmission is not particularly limited. Any protocol used for transmission of text and image data on the computer network 11 may be employed. However, HTTP is preferable in that it is operable to exchange data using a web browser without installing special software.

The storage means 22 includes a plurality of databases configured on storage media of the computer such as a random access memory (RAM), a flash memory, and a hard disk, and database control means 41 for controlling input, output, and update of the databases.

The databases include content database 42, content provider database 43, search database 44, selection database 45, and distribution database 46. The content database 42 stores content data received from the terminal device 12 via the computer network 11, identification information of the content data (simply also referred to as “identification information” hereinafter), and the output quantity thereof. The content provider database 43 stores data (information) on the content provider received from the terminal device 12 via the computer network 11, and billing data for the content provider. The search database 44 stores keywords and search formulas received from the terminal device 13 via the computer network 11, and search results obtained by searching the content data using the keywords and search formulas. The selection database 45 stores information on content selected by the recipient from the search results and a sequence of printing the selected content. The distribution database 46 stores composition data for producing printed matter, the number of copies, and delivery address information on the printed matter.

The editing means 23 provides the terminal device 12 of the content provider with a function that allows the content provider to lay out image and text data to be used as content on a template data stored in a template 51 via the computer network 11 and to generate the content data to be used upon printing as page layout data.

The content data generated as above is received from the terminal device 12 via the data input/output means 21, and is stored in the content database 42. At the same time, the identification information for searching the content data which is used as a retrieval key by the searching means 27 and information on the content provider are received from the terminal device 12 via the data input/output means 21, and respectively stored in the content database 42 and the content provider database 43.

Alternatively, content data created by the content provider without using the editing means 23 as well as the identification information and the content provider information may be received directly by the data input/output means 21 from the terminal device 12.

The content classifying means 24 creates the content table 25. The content table 25 contains the identification information and the content provider information for each of the content data received by the data input/output means 21 and stored in the storage means 22. Alternatively, only the identification information received from the terminal device 12 of the content provider may be stored in the content table 25. Further alternatively, the identification information received from the terminal device 12 and identification information extracted from the text data in the content data using any known method may be stored in the content table 25.

The keyword acquisition means 26 acquires information on the keywords and search formulas to identify content desired by the recipient from the terminal device 13 of the recipient connected to the computer network 11 through the data input/output means 21.

The keywords and search formulas may be directly input as text or extracted or created from answers from the recipient to a questionnaire form sent to the terminal device 13, or a combination of the both.

The information on the keywords and search formulas obtained in this manner is saved in the search database 44.

The searching means 27 searches the content table 25 using the keywords and search formulas stored in the search database 44, identifies information on content that matches the search criteria as content to be printed, and stores the information in the search database 44.

An algorithm used for the search is not particularly limited, and any known algorithm may be employed.

The content selecting means 28 generates selection screen data. The selection screen data has a list of the content to be printed stored in the search database 44 and means for allowing the recipient to select content that he/she actually desires to print and to designate the order of printing. The content selecting means 28 sends the selection screen data to the terminal device 13 of the recipient connected to the computer network 11 via the data input/output means 21. Also, the content selecting means 28 receives, via the data input/output means 21, information on the content selected by the recipient from the list on the selection screen displayed on the terminal device 13 and data on the order of printing designated by the recipient. The content selecting means 28 then stores the data in the selection database 45.

Furthermore, the content selecting means 28 receives the delivery address of printed matter, the number of copies, and information on the number of copies via the data input/output means 21 from the terminal device 13 of the recipient. The content selecting means 28 then stores them in the distribution database 46.

In the case the recipient of printed matter does not desire to select content to be printed from the list or designate the sequence of printing, the system 10 may be configured to allow the recipient to choose to skip the content selecting means (step) 28. Alternatively, the content selecting means 28 may be omitted to create the composition (typesetting) data using the content data of all the content that matches the search criteria.

In these cases, the information on the content that is stored in the search database 44 and matches the search criteria is copied to the selection database 45.

The composition data generating means 29 reads out the content data from the content database 42 using the information on the selected content and the data on the order of printing the content saved in the selection database 45, combines the content in the designated order, and generates the composition data for producing printed matter. The composition data is converted to a predetermined file format such as PostScript or PDF (Portable Document Format) and stored in the distribution database 46 if required.

The distributing means 30 transmits the composition data, and the information on the number of copies and the delivery address stored in the distribution database 46 to the printing device 14.

The billing means 31 calculates the quantity (number) of output for each content data delivered from the sending means 30 to the printing device 14, adds the calculated quantity to the output quantity which has already been stored in the content database 42, generates the billing data for the content provider based on the total output quantity in the content database 42, and stores the billing data in the content provider database 43. The billing means 31 charges the content provider according to the billing data, and sends the billing data to the terminal device 12 of the content provider via the data input/output means 21. The transmission of the billing data may be performed periodically. Alternatively, the transmission of the billing data may be performed every time a fee is charged so that the content provider can keep track of the billing status as needed.

Further alternatively, the system 10 may be provided with means for accessing the billing data stored in the content provider database 43 via the terminal device 12 in real time.

The content provider can evaluate the cost effectiveness of advertisements of the provided content based on the billing data, and decide whether or not to continue providing content based on the evaluation.

If necessary, the system 10 may be provided with deleting means for deleting content via the data input/output means 21 from the terminal device 12, a database for storing usage history of the content provider and the recipient, etc.

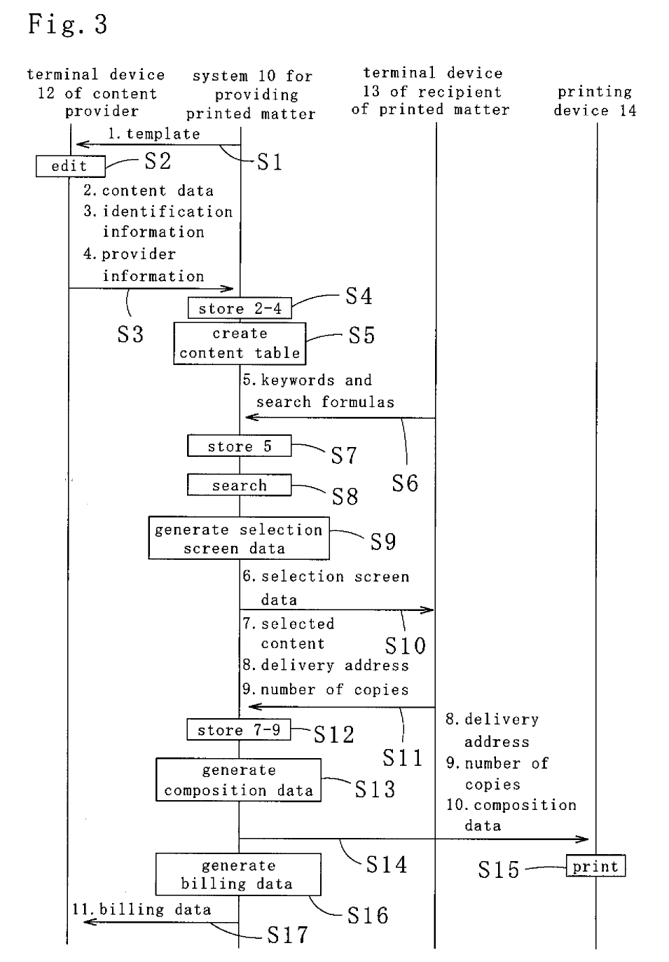

Referring now to the sequence chart of FIG. 3, operation of the system 10 for providing printed matter, i.e., a method for providing printed matter using the system 10 is described.

When the content provider accesses the system 10 from the terminal device 12 of the content provider via the computer network 11, inquiries are made via the data input/output means 21 as to whether or not to edit the content data on the screen. If the content provider chooses to edit the content data on the screen, the editing means 23 of the system 10 displays the template data stored in the template 51 via the data input/output means 21 on the screen of the terminal device 12 (S1).

The content provider edits the image and text data on the screen using the template data, and generates the content data (S2). When the content provider finishes editing, the system 10 makes an inquiry, via the data input/output means 21, as to whether or not to send the content data to the system 10. If the content provider chooses to send the content data, the data input/output means 21 sends an input form to input the identification information on the content data and the content provider information to the terminal device 12. The information input by the content provider and the edited content data are sent to the system 10 via the data input/output means 21 (S3).

The received content data and identification information are stored in the content database 42 and the received content provider information is stored in the content provider database 43 by the content classifying means 24 (S4).

Next the content classifying means 24 creates the content table 25 which stores the identification information and content provider information for each content data. (S5)

When the recipient of printed matter accesses the system 10 from the terminal device 13 of the recipient via the computer network 11, the keyword acquisition means 26 sends the input form for inputting the keywords and search formulas to the terminal device 13 via the data input/output means 21. The keywords and search formulas input by the recipient are sent to the system 10 via the data input/output means 21 (S6).

The received keywords and search formulas are stored in the search database 44 by the keyword acquisition means 26 (S7).

Next the searching means 27 searches the content table 25 using the keywords and search formulas, specifies the content data containing the identification information that matches the search criteria specified by the keywords and search formulas, and stores the specified content data in the search database 44 as data to be printed (S8).

The content selecting means 28 generates the selection screen data The selection screen data contains the list of the content to be printed which is stored in the search database 44 and the means for selecting content which the recipient actually desires to print (S9). Then, the selection screen data is sent to the terminal device 13 of the recipient via the data input/output means 21 (S10).

The information on the content selected by the recipient on the terminal device 13 is received via the data input/output means 21 and stored in the selection database 45 by the content selecting means 28.

Next, the content selecting means 28 generates the selection screen data having the means for designating the order of printing the selected content, sends the data to the terminal device 13 via the data input/output means 21, and stores the order of printing the content designated by the recipient in the selection database 45. Furthermore, the information on the delivery address and the number of copies input by the recipient on the terminal device 13 is received via the data input/output means 21, and stored in the distribution database 46 by the content selecting means 28 (S11, S12).

The composition data generating means 29 retrieves the content data from the content database 42 using the information on the selected content and the data on the sequence of printing stored in the selection database 45, combines the information in the designated order, and generates the composition data for producing printed matter. Then, the composition data generating means 29 converts the data to a predetermined format such as a page description language according to need, and stores the composition data in the distribution database 46 (S13).

The sending means 30 sends the composition data, and the information on the number of copies and the delivery address stored in the distribution database 46 to the printing device 14 (S14).

The printing device 14 carries out printing operation using the composition data received from the sending means 30. In the case the printing device 14 is an on-demand printer, bookbinding may also be carried out. The printing operation is completed in several hours after the printing device 14 receives the content data from the sending means 30.

The printing device 14 may also create mailing labels for delivery using the delivery address information received from the sending means 30. Alternatively, the delivery address may be printed on the front cover or the back cover of the printed matter (S15).

The printed matter is dispatched to the delivery address designated by the recipient via mail, parcel delivery service, etc.

The billing means 31 calculates the output quantity for each content data distributed from the sending means 30 to the printing device 14, and adds the calculated quantity to the output quantity already stored in the content database 42. Then, the billing means 31 generates the billing data for the content provider based on the total output quantity stored in the content database 42, and stores the billing data in the content provider database 43 (S16).

Also, the billing means 31 carries out fee charging such as issue of invoices and automatic withdrawal from a bank account based on the billing data, and at sends the billing data via the data input/output means 21 to the terminal device 12 of the content provider. The transmission of the billing data may be executed periodically. Alternatively, the data transmission may be performed every time a fee is charged so that the content provider can keep track of the billing status as needed.

Further alternatively, the content provider may access the billing data stored in the content provider database 43 through the terminal device 12 by the means for accessing the billing data in real time as needed. (S17)

What is claimed is:

1. A method for providing printed matter using a computer connected to a computer network, the printed matter having content selected by a recipient of the printed matter via a screen displayed on a terminal device connected to the computer network, the method comprising the steps of:
(A) receiving content data, identification information of the content data, and content provider information from a terminal device of a content provider via the computer network by data input/output means of the computer, and storing the content data, the identification information, and the content provider information in storage means of the computer;
(B) creating a content table in which the content provider information and the identification information are stored for each of the content data stored in the storage means by content classifying means of the computer;
(C) acquiring a keyword and a search formula necessary to identify content desired by the recipient from the terminal device of the recipient, and storing the keyword and search formula in the storage means by keyword acquisition means of the computer via the computer network;
(D) searching the content table by searching means of the computer using the acquired keyword and the search formula to identify content that matches a search criterion;
(E) reading content data of the identified content from the storage means by composition data generating means of the computer, and generating composition data using the content data;
(F) acquiring delivery address information of the printed matter from the terminal device of the recipient by the data input/output means, and storing the delivery address information in the storage means;
(G) sending the composition data and the delivery address information to a printing device connected to the computer by sending means of the computer; and
(H) generating billing data for the content provider according to output quantity of the content by billing means of the computer.

2. The method as defined in claim 1, further comprising, prior to the step (A), the step of:
(I) providing the terminal device of the content provider with a function to edit image and text data on a screen of the terminal device of the content provider and generate the content data by editing means of the computer via the data input/output means.

3. The method as defined in claim 1, further comprising, between the steps (D) and (E), the step of:
(J) displaying a list of the content that matches the search criterion on the screen of the terminal device of the recipient by content selecting means of the computer to allow the recipient to select desired content acquiring information on the selected content from the terminal device of the recipient via the data input/output means, and storing the information in the storage means,
wherein the step (E) includes generating the composition data by the composition data generating means using content data of the selected content.

4. The method as defined in claim 2, further comprising, between the steps (D) and (E), the step of:
(J) displaying a list of the content that matches the search criterion on the screen of the terminal device of the recipient by content selecting means of the computer to allow the recipient to select desired content acquiring information on the selected content from the terminal device of the recipient via the data input/output means, and storing the information in the storage means,
wherein the step (E) includes generating the composition data by the composition data generating means using content data of the selected content.

5. A system for providing printed matter, comprising:
data input/output means for sending and receiving data to and from terminal devices of a content provider and a recipient of printed matter via a computer network, the terminal devices being connected to the computer network;
storage means for storing content data received from the terminal device of the content provider via the data input/output means, identification information of the content data, content provider information, a keyword and a search formula for identifying content desired by the recipient received from the terminal device of the recipient via the data input/output means, information on content selected by the recipient, and delivery address information of printed matter in which the selected content is printed;
content classifying means for creating a content table in which the content provider information and the identification information are stored for each of the content data stored in the storage means;
keyword acquisition means for acquiring the keyword and the search formula for identifying the content desired by the recipient from the terminal device of the recipient via the computer network;
searching means for searching the content table using the keyword and the search formula to identify content that matches a search criterion;
composition data generating means for generating composition data from content data of the identified content;
sending means for sending the composition data and the delivery address information to a printing device via the computer network; and
billing means for calculating output quantity for each of the content data sent from the sending means and generating billing data for the content provider according to the output quantity.

6. The system as defined in clam 5, further comprising editing means for providing the terminal device of the content provider with a function to edit image and text data on a screen of the terminal device of the content provider to generate the content data.

7. The system as defined in claim 5, further comprising content selecting means for creating a list of candidates of the content identified by the searching means, sending the list to the terminal device of the recipient via the data input/output means to allow the recipient to select content to be printed, and receiving information on the selected content via the data input/output means,
wherein the composition data generating means generates the composition data from content data of the selected content.

8. The system as defined in claim 6, further comprising content selecting means for creating a list of candidates of the content identified by the searching means, sending the list to the terminal device of the recipient via the data input/output means to allow the recipient to select content to be printed, and receiving information on the selected content via the data input/output means,
wherein the composition data generating means generates the composition data from content data of the selected content.

9. A program for providing printed matter, causing a computer connected to a computer network to function as:
(A) means for receiving content data, identification information of the content data, and content provider information from a terminal device of a content provider via the computer network, and storing the content data, the identification information, and the content provider information in storage means of the computer;
(B) means for creating a content table in which the content provider information and the identification information are stored for each of the content data stored in the storage means;
(C) means for acquiring a keyword and a search formula for identifying content desired by a recipient of printed matter from a terminal device of the recipient via the computer network, and storing the keyword and the search formula in the storage means;
(D) means for searching the content table using the acquired keyword and search formula to identify content that matches a search criterion;
(E) means for combining content data of the identified content to generate composition data;
(F) means for acquiring delivery address information of printed matter from the terminal device of the recipient after the generation of the composition data;
(G) means for sending the composition data and the delivery address information to a printing device; and
(H) means for generating billing data for the content provider according to output quantity of the content.

10. The program as defined in claim 9, further causing a computer to function as:
(I) means for providing the terminal device of the content provider with a function to edit image and text data on a screen of the terminal device of the content provider and generate the content data.

11. The program as defined in claim 9, further causing a computer to function as:
(J) means for displaying a list of the content that matches the search criterion on a screen of the terminal device of the recipient to allow the recipient to select desired content, and acquiring information on the selected content from the terminal device of the recipient,
wherein the means (E) further includes generating the composition data based on content data of the selected content.

12. The program as defined in claim 10, further causing a computer to function as:
(J) means for displaying a list of the content that matches the search criterion on a screen of the terminal device of the recipient to allow the recipient to select desired content and acquiring information on the selected content from the terminal device of the recipient,
wherein the means (E) further includes generating the composition data based on content data of the selected content.
